(19) United States
(12) Patent Application Publication
(10) Pub. No.: US 2025/0372076 A1
(43) Pub. Date: Dec. 4, 2025

(54) AI-VOICE CALL ESCALATION AND EMPATHY SYSTEM

(71) Applicant: CELLIGENCE INTERNATIONAL LLC, Guaynabo, PR (US)

(72) Inventors: Pavan AGARWAL, Dorado, PR (US); Gabriel Albors SANCHEZ, San Juan, PR (US); Jonathan Ortiz RIVERA, San Juan, PR (US)

(73) Assignee: CELLIGENCE INTERNATIONAL LLC, Guaynabo, PR (US)

(21) Appl. No.: 19/296,774

(22) Filed: Aug. 11, 2025

Related U.S. Application Data
(63) Continuation-in-part of application No. 18/135,703, filed on Apr. 17, 2023, now Pat. No. 12,393,433.
(60) Provisional application No. 63/332,205, filed on Apr. 18, 2022.

(51) Int. Cl. G10L 13/033; G10L 13/027; G10L 15/06; G10L 15/18; G10L 15/22; G10L 25/63

(52) U.S. Cl. CPC G10L 13/0335; G10L 13/027; G10L 15/063; G10L 15/1815; G10L 15/22; G10L 25/63; G10L 2015/0635

(57) ABSTRACT

Disclosed are systems and methods for enabling collaborative AI-human voice interactions in an outbound call environment. An AI voice engine synthesizes real-time speech responses, optionally using a voice model representing a specific human agent. A sentiment analysis engine monitors user speech to classify emotional state, and an emotion modulation engine dynamically adjusts tone, pitch, and prosody of AI output based on inferred sentiment or operator commands. An operator console allows live human oversight, including editing AI-generated text, selecting emotional tone presets, or overriding responses entirely. The system supports real-time disclosure of AI identity and records call metadata for compliance. Training modules log operator interventions, sentiment patterns, and interaction outcomes to improve future AI behavior, enabling a scalable voice platform that balances automation with human empathy.

### RELATED APPLICATIONS

This application a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### BACKGROUND

Traditional AI-driven voice systems for outbound calls often lack emotional nuance and regulatory safeguards, leading to mechanical user experiences and heightened legal risks. Systems that autonomously dial and deliver pre-scripted messages without meaningful human intervention risk violating consumer protection laws, particularly the Telephone Consumer Protection Act (TCPA). Furthermore, the inability of current systems to detect, interpret, and adapt to a user's emotional state during a live call results in reduced customer trust and satisfaction.

Existing solutions fail to offer a truly hybrid approach where a human operator can collaborate with the AI in real time—not only supervising but influencing the AI's tone, inflection, and conversational decisions. There is also a lack of adaptive emotional intelligence, whereby AI systems learn from prior human interventions to improve future responses.

### SUMMARY

The present disclosure relates to systems and methods for facilitating real-time AI-generated voice calls with integrated human oversight, emotional tone modulation, and regulatory compliance. The disclosed architecture enables a hybrid model in which an AI-generated voice avatar conducts a live call with a customer, while a human operator monitors, adjusts, and optionally overrides the interaction in real time.

The system includes a voice call initiation module configured to launch outbound calls under human supervision, an AI voice engine that generates speech output using natural language generation and text-to-speech synthesis (including personalized voice twins), and an operator console that displays the evolving transcript, suggested AI responses, and emotional tone controls. A sentiment analysis engine classifies the emotional state of the customer based on voice input, and an emotion modulation interface allows the operator to influence AI delivery style using real-time controls such as empathy sliders or pre-set tone buttons.

In some embodiments, the system provides an initial AI-generated greeting disclosing the synthetic nature of the voice and the presence of a human operator. During the conversation, the operator may intervene by editing the AI's response or typing a custom message that is converted to voice output using the same voice model. All interactions—including tone adjustments, overrides, and user sentiment transitions—are logged into an interaction data store for future training and behavioral refinement of the AI system.

The disclosed framework ensures TCPA-compliant outbound engagement, preserves human control over sensitive interactions, and allows scalable deployment of emotionally intelligent AI voice avatars tailored to specific personas or brands.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram illustrating an exemplary system architecture for AI voice call initiation, emotional tone modulation, and live operator collaboration, according to an implementation of the disclosure.

FIG. 2 is a flowchart illustrating the AI-human voice interaction workflow, according to an implementation of the disclosure.

FIG. 3 is a graphical user interface (GUI) illustrating an operator console with

emotional tone selection, AI-generated message suggestions, and real-time editing tools, according to an implementation of the disclosure.

FIGS. 4A-4B illustrate a voice call workflow enabling real-time collaboration between a live human operator and a personalized AI voice avatar, according to an implementation of the disclosure.

FIG. 5 is a graphical user interface (GUI) presented to a human operator during a live AI voice interaction, according to an implementation of the disclosure.

FIG. 6 is a graphical user interface (GUI) illustrating real-time sentiment analysis, according to an implementation of the disclosure.

FIG. 7 is a graphical user interface (GUI) displaying visual mood states using a dynamic emotion wave model, according to an implementation of the disclosure.

FIG. 8 illustrates a collaborative response generation interface, according to an implementation of the disclosure.

FIG. 9 illustrates an example computing system that may be used in implementing various features of embodiments of the disclosed technology.

Described herein are systems and methods for AI-driven voice communication that combines personalized voice synthesis, emotional tone modulation, and real-time human oversight to deliver context-aware, compliant, and emotionally responsive customer interactions. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The disclosed system provides a novel AI-human hybrid voice communication architecture that improves how AI voice systems interact with users by incorporating real-time emotional feedback, human-in-the-loop supervision, and dynamic control of tone and delivery—while also offering operational safeguards that incidentally ensure compliance with legal frameworks such as the Telephone Consumer Protection Act (TCPA).

Conventional automated voice systems typically rely on rigid prerecorded scripts or narrowly parameterized speech generation logic, which results in static and often unnatural user experiences. These systems may use basic logic to determine message content, but they do not adjust their tone, inflection, or responsiveness to align with the recipient's emotional state in real time. Furthermore, most lack effective collaboration mechanisms with human agents, instead relying on fallback or escalation models that require manual handoff rather than continuous co-management.

Additionally, many current systems fail to provide sufficient transparency and compliance controls, particularly with respect to consumer protection laws like the TCPA. Systems that initiate calls without meaningful human input, or that use artificial voice content without proper consent or disclosure, may trigger regulatory liability. Even in cases where a human is nominally involved, the absence of an integrated UI for human oversight, intervention, and tonal adjustment reduces the system's ability to operate effectively in high-compliance environments.

Such limitations result in user dissatisfaction, poor engagement rates, and increased legal exposure. They also constrain the use of automated voice technology in sensitive or regulated industries such as financial services, healthcare, and customer support, where empathy, trust, and legal compliance are critical.

The disclosed system introduces several technical advancements over conventional voice automation systems. First, the architecture is designed to support hybrid control by integrating a live operator interface with an AI-driven voice communication engine. This allows the system to offer real-time oversight, refinement, and tonal modulation of AI-generated responses, enabling a far more natural and responsive experience.

Second, the system includes dynamic emotional control mechanisms, such as sliders and pre-configured emotional intent buttons, that enable the operator to adjust the AI's tone, pacing, and language selection mid-conversation. These controls directly impact the AI's speech synthesis engine and NLP model outputs, allowing emotionally nuanced responses that align with user sentiment.

Third, the system leverages real-time sentiment detection from transcribed user speech to influence system behavior. Mood tags are surfaced to the operator, and the AI may auto-adjust its tone based on recognized shifts in sentiment, reducing the delay between emotional input and empathetic response. This not only improves human-computer interaction quality but also enhances AI adaptability.

Fourth, the system includes a voice twin engine capable of synthesizing individual speaker profiles, enabling the AI to speak using voices that are contextually or professionally aligned (e.g., mimicking a specific loan officer's voice). This consistency enhances customer familiarity and trust without requiring live agent availability throughout the call.

Fifth, training data from each call is used to adapt AI behavior over time. Operator interventions, mood adjustments, and outcome indicators (e.g., call duration, user sentiment change) are logged and fed into learning modules to improve future AI tone prediction, fallback behavior, and message timing.

Finally, the system's modular design explicitly supports legal compliance use cases by requiring human initiation of outbound calls, offering flexible scripting options, and enabling upfront AI identity disclosure. These features allow the system to operate effectively in jurisdictions with stringent voice automation rules, without reducing performance or personalization.

Together, these improvements create a voice interaction framework that is emotionally intelligent, legally adaptable, and operator-augmented-well beyond the capabilities of traditional IVR or scripted bot systems.

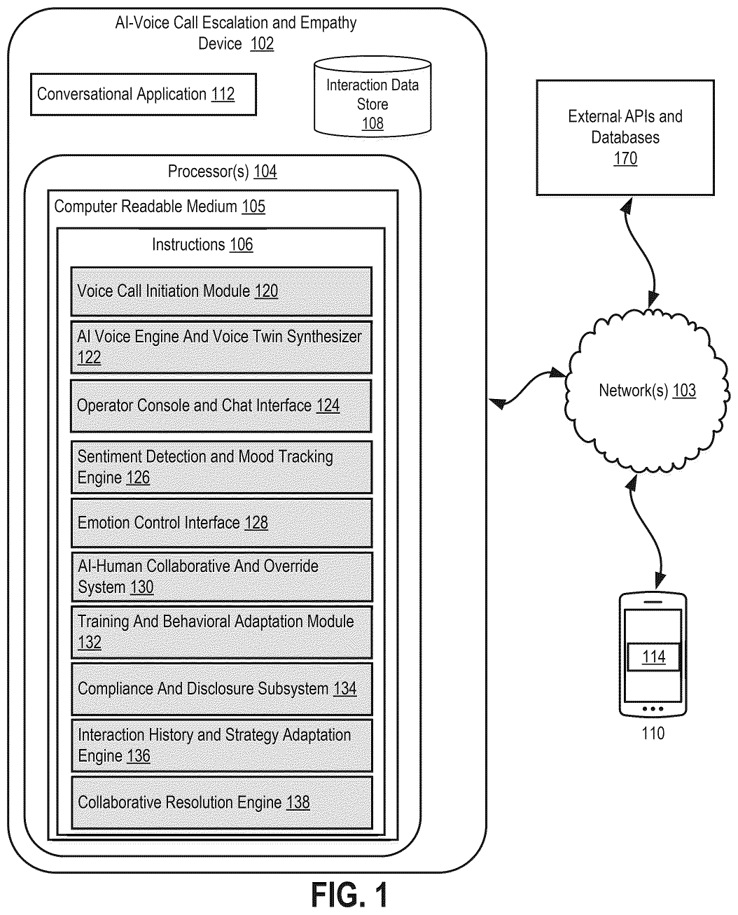

The disclosed system operates within a modular, service-oriented architecture designed to support scalable AI voice interactions guided by real-time human input. FIG. 1 provides a high-level system overview, showing key functional modules and data flows between components.

At a high level, the system includes (i) a call initiation and identity disclosure module, (ii) an AI voice generation engine with optional voice twin synthesis, (iii) a live operator console for oversight and intervention, (iv) a sentiment detection and emotional modulation subsystem, (v) an emotion control interface, (vi) an AI-human collaboration and override system, (vi) a training and behavioral adaptation engine, and (viii) a compliance and override module.

These components are deployed in a cloud-based or enterprise-hosted environment and may communicate through secured APIs, message brokers, or real-time communication protocols. The architecture is designed to maintain low-latency response during live calls, ensure fallback handling for regulatory compliance, and support continuous learning through operator-AI collaboration.

In the following sections, each module is described in further detail with reference to specific functions, interactions, and user interface elements.

The Voice Call Initiation and Identity Disclosure Module is responsible for beginning each outbound communication session under operator supervision. This module includes an interface that allows a human operator to manually select a contact or input a phone number and initiate a call with a single click, thereby ensuring that the call is not automatically generated by the system. The dialing process is explicitly designed to support regulatory compliance by requiring human initiation as a precondition to call placement.

Upon connection, the system enables the operator to either speak directly to the recipient or type a greeting, which is then rendered in a synthesized AI voice. This greeting includes a clear disclosure that the call is being conducted with the assistance of an AI voice agent. The module supports different disclosure formats depending on context and jurisdiction, such as stating, “This is [Name]'s AI twin speaking on a recorded line, with a live assistant also present.” This ensures compliance with legal requirements concerning the use of artificial or prerecorded voices.

In cases where a live human voice is used initially and the AI takes over subsequently, the system records the transition point and maintains a disclosure log. Additionally, metadata regarding who initiated the call, what method of disclosure was used, and whether AI content was delivered is tracked and can be exported for audit purposes. This foundational module sets the tone for the interaction and provides the structural prerequisites for compliant and controlled engagement between users and the AI voice assistant.

The AI Voice Generation Engine is responsible for converting approved text-based inputs—whether composed by the operator, suggested by the AI, or collaboratively refined—into lifelike speech. This engine includes natural language processing (NLP) and text-to-speech (TTS) capabilities that allow it to render responses using configurable tone, pacing, and emotional inflection. When integrated with the voice twin synthesis capability, the engine can replicate the voiceprint of a specific individual, such as a loan officer, to create a sense of familiarity and personalization.

The engine supports dynamic voice profile switching, meaning the same conversation may alternate between multiple AI-generated voices based on operator control or contextual triggers. Voice tone is further modulated in real time through signals from the emotion control interface and sentiment detection subsystem, described further below. The AI Voice Generation Engine also supports fallback behaviors, such as pausing or switching to human input in response to operator overrides.

The Live Operator Console serves as the central user interface through which a human agent monitors, guides, and collaborates with the AI during an active call. The console presents the current conversation flow in text form, with time-stamped transcriptions of user speech, AI-generated suggestions, and operator inputs. It also displays real-time sentiment indicators and emotion tagging to help inform operator decisions.

Within the console, the operator can select from AI-suggested responses, manually edit them, or type new responses entirely. The interface allows one-click approval and transmission of messages, which are then delivered to the customer via the AI voice engine. Controls for emotion modulation, voice tone, and call pacing are embedded directly into the console, streamlining decision-making during live engagements.

The Sentiment Detection and Emotional Modulation Subsystem continuously analyzes the user's speech input for tone, sentiment, and mood indicators using a combination of NLP and audio analysis models. This subsystem assigns dynamic mood tags (e.g., “happy,” “confused,” “frustrated”) and updates them in real time as the conversation evolves.

These sentiment tags inform both the operator and the AI response engine. For example, if the customer becomes agitated, the system may suggest a more empathetic tone or trigger a recommendation for operator takeover. The mood data is displayed on the Live Operator Console and also logged for long-term behavioral modeling.

The Emotion Control Interface enables the operator to shape the tone and style of the AI's voice output through real-time controls. The interface includes buttons or sliders for emotional states such as “Celebrate,” “Reassure,” “Show Urgency,” and “Empathize,” among others. These inputs modify the language choices and speech patterns generated by the AI voice engine, allowing the conversation to feel more natural and emotionally responsive.

Each selected emotion is visually reinforced through UI feedback (e.g., color-coded tags or active-state highlights) and applied across subsequent AI utterances until a new emotion is selected or the conversation context resets. This allows for dynamic, adaptive tone management during live calls, enhancing customer satisfaction and rapport.

The AI-Human Collaboration and Override System enables seamless coordination between a live operator and the AI-driven voice assistant during an active call. The system is designed to maintain conversational continuity while allowing the human agent to supervise, intervene, or redirect the flow of the conversation in real time.

The operator interface includes a live chat view that displays transcribed speech from the customer along with AI-suggested responses. The operator may approve a suggestion as-is, edit or rewrite the response before sending, or input an entirely new message. Once finalized, the selected message is rendered into speech using the AI voice engine, maintaining tone and voice continuity.

An override control is provided to allow the operator to pause the AI's output and take full control of the conversation. When this feature is activated, AI voice generation is temporarily suspended, and the human operator may choose to speak directly or submit a text response that is spoken using either the AI's synthesized voice or an alternate human-like voice profile.

To preserve conversational flow, the system includes state-tracking mechanisms that enable the AI to resume participation after human intervention. If the customer's tone or input indicates confusion, distress, or a change in subject matter, the system may prompt the operator with context-aware guidance, suggest escalation to a specialist, or transition to a pre-defined fallback routine.

This collaborative framework allows the AI to deliver timely, empathetic responses while enabling the operator to intervene when needed, thereby enhancing both operational control and user trust in dynamic or regulated environments.

The Training and Behavioral Adaptation Engine captures data from each interaction—including operator interventions, emotional control changes, sentiment fluctuations, and final call outcomes—and uses this information to improve the system's future performance. The engine employs machine learning models to refine tone prediction, AI-generated response quality, and trigger thresholds for human intervention.

This component supports continual learning and personalization across users and contexts. It may also generate training data for supervised operator-AI collaboration, enabling better AI autonomy in recurring or low-risk conversational paths while preserving human fallback for sensitive interactions.

The Compliance and Regulatory Support Module ensures that all outbound calls and voice interactions adhere to legal and policy requirements. It manages the full compliance framework by logging call initiation methods, documenting whether a human operator triggered the call, and verifying whether appropriate AI disclosures were provided at the outset of the conversation.

The system also captures the nature of the voice output—whether it was delivered through an AI-generated synthetic voice, a human-recorded message, or a combination thereof. Consent management is incorporated into this module, allowing the platform to track whether prior express consent or prior express written consent was obtained depending on the nature of the call.

This module supports customization of disclosure scripts and consent prompts based on geographic and regulatory contexts. In addition, it maintains detailed logs that can be exported in standardized formats for use in audits, investigations, or compliance reporting. These records provide a full audit trail of voice interactions, including timestamps, operator actions, AI voice activity, and fallback events. As regulatory environments evolve, this component enables the system to remain adaptable and transparent while maintaining high legal assurance.

In some embodiments, the system leverages historical interaction data—including prior calls, emails, and outcome signals—to identify strategies that have been effective in similar scenarios. This enables context-sensitive decision-making tailored to customer type, industry, or office profile. For instance, if the system detects that a phone number consistently routes to voicemail, it may automatically switch to email follow-up. The AI Voice Call Escalation and Empathy System monitors email open signals to determine whether and when to re-engage, thereby optimizing follow-up timing and reducing user friction. These adaptive logic rules may be updated continuously using feedback from the training and behavioral adaptation module.

FIG. 1 illustrates an example system architecture 100 for an AI Voice Call Escalation and Empathy System, including an AI-driven voice communication device 102, a client device 110, external APIs and databases 170, and a network 103 configured to facilitate real-time voice interactions and data exchange.

The AI-driven communication device 102 includes one or more processors 104 and a computer-readable medium 105 that stores executable instructions 106 comprising a set of functional modules that collectively power the real-time AI-human collaboration system. These modules include: a Voice Call Initiation Module 120 configured to initiate outbound voice calls under operator supervision; an AI Voice Engine and Voice Twin Synthesizer 122 for rendering approved responses in synthesized speech, including personalized voice models; an Operator Console and Chat Interface 124 to enable real-time human oversight, approval, and intervention in live conversations; a Sentiment Detection and Mood Tracking Engine 126 that analyzes customer speech input to infer emotional state; an Emotion Control Interface 128 through which the operator adjusts the tone and delivery style of the AI voice; an AI-Human Collaboration and Override System 130 that coordinates manual control, fallback logic, and escalation pathways; a Training and Behavioral Adaptation Module 132 that logs operator-AI interaction data for continual improvement; and a Compliance and Disclosure Subsystem 134 configured to monitor consent status, call metadata, and regulatory adherence.

The system also includes a conversational application 112 that acts as the primary user interface for operator interaction with the AI, and an interaction data store 108 that logs conversations, override events, tone selections, and compliance disclosures for training and audit purposes.

The client device 110 includes a user interface 114 and is communicatively connected to device 102 over network(s) 103. The client device receives synthesized speech from the AI Voice Engine, which is rendered to the user in real time. It also transmits user voice input for analysis by sentiment detection and operator review.

The AI-driven voice call system can also access external APIs and databases 170 through network 103. These external sources may include consent management systems, customer CRMs, or third-party regulatory data sources that support verification, personalization, and legal compliance.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

The disclosed system operates within a modular, service-oriented architecture designed to support scalable AI voice interactions guided by real-time human input. FIG. 1 provides a high-level system overview, showing key functional modules and data flows between components.

At a high level, the system includes (i) a call initiation and identity disclosure module, (ii) an AI voice generation engine with optional voice twin synthesis, (iii) a live operator console for oversight and intervention, (iv) a sentiment detection and emotional modulation subsystem, (v) an emotion control interface, (vi) an AI-human collaboration and override system, (vii) a training and behavioral adaptation engine, and (viii) a compliance and regulatory support module.

These components are deployed in a cloud-based or enterprise-hosted environment and may communicate through secured APIs, message brokers, or real-time communication protocols. The architecture is designed to maintain low-latency response during live calls, ensure fallback handling for regulatory compliance, and support continuous learning through operator-AI collaboration.

In the following sections, each module is described in further detail with reference to specific functions, interactions, and user interface elements.

The Voice Call Initiation Module 120 initiates outbound calls under human operator supervision. This module ensures compliance by requiring manual initiation (e.g., a “click to dial”) and optionally delivers the initial AI-generated disclosure greeting. It tracks call start metadata and ensures disclosure requirements are met before conversation proceeds.

The AI Voice Engine and Voice Twin Synthesizer 122 converts approved text responses into synthetic speech, optionally using personalized voice models (e.g., a loan officer's voice twin). It supports emotional tone modulation and dynamic voice switching based on context or operator controls.

The Operator Console and Chat Interface 124 is the real-time dashboard through which a human monitors the conversation, approves or edits AI messages, selects emotion tone buttons, and initiates overrides. It displays transcripts, sentiment cues, and controls to escalate, edit, or take over the dialogue.

This module receives customer voice input and applies NLP and audio analysis to infer emotional states (e.g., confused, frustrated, happy). These signals help drive dynamic tone modulation, trigger alerts, and provide training signals for adaptive behavior.

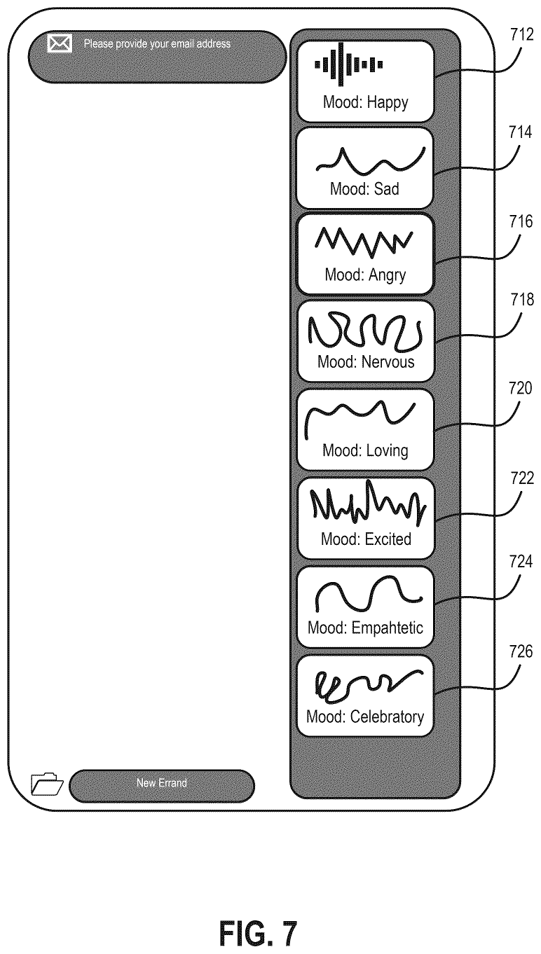

In some embodiments, the sentiment detection and mood tracking engine 126 further includes a dynamic emotion wave model, which represents a user's emotional state as a continuously updated waveform derived from voice tone, pacing, and linguistic cues. As shown in FIG. 7, these waveforms may be visualized in the operator interface as labeled emotional states (e.g., happy, sad, angry, empathetic) with corresponding waveform icons that evolve over time. When a significant emotional shift or engagement drop is detected—such as a sudden spike in agitation or extended silence—the system may trigger a real-time alert to the human operator. These alerts prompt timely human intervention, similar to a clinical monitoring system, ensuring that emotional context is handled with empathy and precision.

When significant shifts in emotion are detected—such as a transition from calm to agitated or from engaged to withdrawn—the engine can trigger alerts to the operator. These alerts function as real-time escalation cues, prompting the human to intervene at the most emotionally relevant moments. The system may use this feedback to adjust AI voice tone, escalate to a human-curated message, or pause AI output altogether. This approach enhances emotional intelligence and ensures that operator attention is directed when human empathy is most critical, much like a clinical system that monitors patient vitals and escalates when anomalies occur.

The Emotion Control Interface 128 allows operators to manually guide the tone of the AI voice by selecting options like “Celebrate” or “Show Urgency.” These selections influence the prosody and linguistic style of the synthesized output.

This module handles logic related to human-in-the-loop controls. It pauses AI output on demand, allows takeover by human agents, handles fallback transitions, and tracks manual overrides during live conversations.

This module logs operator interactions, sentiment signals, and override decisions to create a dataset for improving future AI behavior. It enables reinforcement learning and fine-tuning based on real-world usage.

This module ensures regulatory adherence, tracks whether human or AI voices are used, and verifies whether proper disclosures and consent are in place. It logs all relevant call compliance metadata for audit purposes.

The interaction history and strategy adaptation engine 136 enables the system to learn from past communications—both successful and unsuccessful—in order to fine-tune future call strategies, emotional tone patterns, and escalation thresholds. This engine aggregates historical data from voice calls, email follow-ups, and chat interactions, using structured metadata to analyze variables such as recipient role, engagement outcomes, and context shifts. For example, the system can determine which approach is most effective for loan officers in specific regions or identify when voicemail detection should trigger a switch to email-based re-engagement.

In some embodiments, the system automatically detects when a call is routed to voicemail and initiates a follow-up email workflow. The system can also monitor email open events and time the re-engagement accordingly to maximize responsiveness. By identifying patterns across engagements, the strategy adaptation engine personalizes conversation flows for different customer types and business contexts. These insights are shared with the AI voice generation engine 122 and emotion control interface 128 to dynamically modulate speech tone, urgency, and delivery tactics. Over time, this engine refines system behavior for both automated and operator-assisted interactions, increasing conversion rates, satisfaction scores, and overall conversational efficacy.

The collaborative resolution engine 138 supports co-creation of conversational responses between AI Voice Call Escalation and Empathy system and a human operator when the system encounters a novel or ambiguous scenario. Rather than defaulting to fallback or escalation logic, the engine initiates a real-time collaboration protocol in which both AI and operator contribute to the final output. For instance, when the AI encounters a situation for which no prior pattern matches exist—such as a highly specific user concern or multi-party decision context—it may suggest a partial or tentative response, which the operator can refine or replace before delivery. This process is facilitated through the operator console and chat interface 124, where real-time draft responses are flagged for joint review. The operator may contribute emotional framing, domain expertise, or linguistic nuance that the AI then integrates and reproduces in the selected voice persona. The resulting output—termed the “empathetic final result”—is delivered as a unified voice response from the AI twin. The collaborative resolution engine ensures that ambiguous or high-risk interactions are handled with a blend of human intuition and AI efficiency. It also logs the collaborative steps taken, feeding them back into the training and behavioral adaptation module 132 to improve future autonomous handling of similar cases.

This process is facilitated through the operator console and chat interface 124, where real-time draft responses are flagged for joint review. The operator may contribute emotional framing, domain expertise, or linguistic nuance that the AI then integrates and reproduces in the selected voice persona. The resulting output—termed the “empathetic final result”—is delivered as a unified voice response from the AI twin.

The collaborative resolution engine ensures that ambiguous or high-risk interactions are handled with a blend of human intuition and AI efficiency. It also logs the collaborative steps taken, feeding them back into the training and behavioral adaptation module 132 to improve future autonomous handling of similar cases.

The system also includes a Conversational Application 112 that acts as the operator interface, and an Interaction Data Store 108 for logging conversations, tone selections, override behavior, and compliance artifacts.

Client device 110 includes a user interface 114 and is connected over network

103. It plays audio generated by the AI voice engine and sends user speech back into the system. External APIs and databases 170 support compliance verification and contextual personalization.

Client computing device 110 may be any suitable voice-enabled endpoint, such as a smartphone, landline, or VoIP terminal, used by the recipient of the AI-initiated voice call. The device receives audio generated by the Text-to-Speech and Voice Synthesis Module 126 and transmits user responses back to the system in real time. In typical use, the client device 110 does not require any special application or interface beyond standard voice telephony, enabling seamless integration across a wide range of consumer devices.

The client computing device 110 operates as a passive audio endpoint in most embodiments. The user hears a voice synthesized by the AI system, which may be tailored to reflect a specific persona or emotional tone. Depending on detected sentiment or response ambiguity, the system may escalate the interaction by routing the call to a live operator, with the transition occurring transparently on the client device.

In some embodiments, the client device 110 may also display supplementary visual content, such as SMS prompts or web links, triggered by the AI Voice Engine and Voice Twin Synthesizer 122 or the Compliance and Disclosure Subsystem 134. However, the primary mode of communication remains voice-based, with the device relaying input to the system for processing by downstream modules such as the Sentiment Detection and Mood Tracking Engine 126 and, when applicable, the AI-Human Collaboration and Override System 130.

In some embodiments, an AI assistant is orchestrated by the AI-driven communication device 102 and facilitated through modules such as the AI Voice Engine 122, Sentiment Detection Engine 126, and the Operator Console 124. The assistant serves as the voice-facing interface, interpreting live customer speech, selecting appropriate emotional tones, and routing responses through either automated synthesis or human-in-the-loop escalation. It helps ensure coherent, regulated, and emotionally responsive interactions during outbound calls.

The assistant operates in a hybrid model, automatically generating responses via the AI Voice Engine and Voice Twin Synthesizer 122, while allowing real-time human intervention through the Operator Console 124 and AI-Human Override System 130. This allows autonomous response delivery when confidence is high and seamless handoff to human agents when ambiguity, escalation conditions, or compliance risks are detected.

External APIs and services 170 represent third-party systems and data sources that augment the functionality of the AI voice interaction system. These services may include identity verification platforms, regulatory compliance databases, emotional tone calibration libraries, telecommunication backbones, and natural language understanding (NLU) toolkits. The system accesses these services via secure API calls to perform tasks such as validating caller identification, enhancing sentiment classification, or retrieving up-to-date compliance rules (e.g., TCPA updates or contact consent registries).

In some embodiments, the emotion modulation subsystem 130 may query third-party emotional intelligence platforms to calibrate AI-generated tone based on industry-specific guidelines or user feedback history. Similarly, the training and behavioral adaptation engine 132 may retrieve voice fingerprint data, override statistics, or escalation metadata from integrated partner systems to improve operator guidance and continuous learning.

Access to external APIs is governed by permissions, throttling rules, and privacy constraints enforced by the compliance and override module 134. These integrations enhance the adaptability, accuracy, and legal defensibility of the AI voice interaction platform without increasing system overhead.

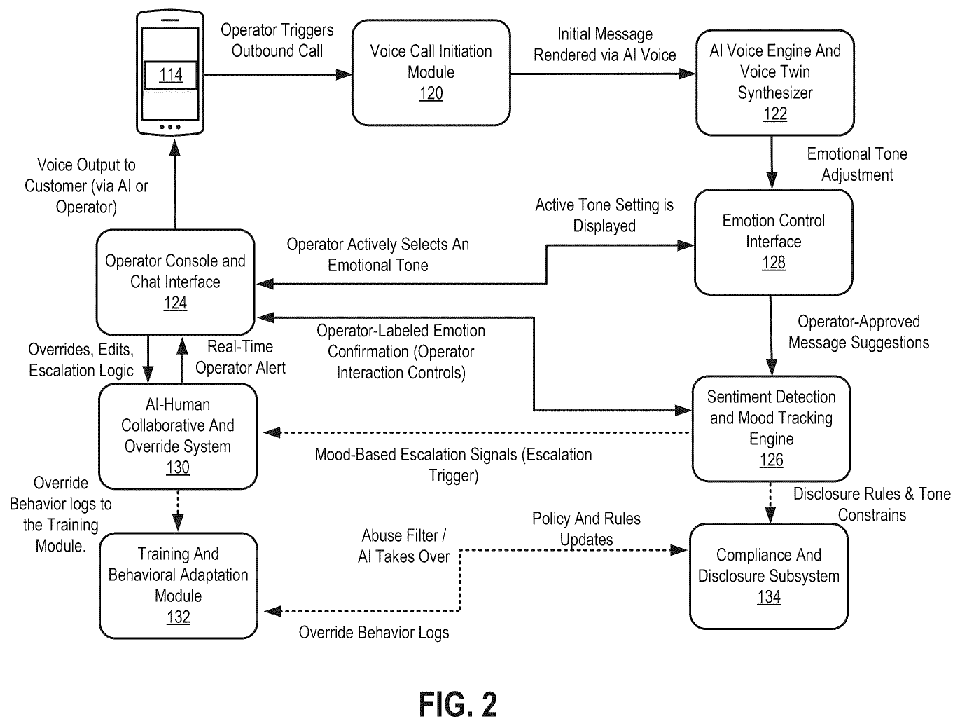

FIG. 2 illustrates a system-level process architecture for managing AI voice calls with real-time emotional modulation and human override capabilities. The system is initiated by a human operator who triggers an outbound call via the Voice Call Initiation Module 120. The call is placed to a client device 110, and the initial message may be rendered using an AI-generated voice synthesized by the AI Voice Engine and Voice Twin Synthesizer 122.

In some embodiments, the first spoken message delivered to the call recipient is generated entirely from human-authored input. The human operator, selected by the system based on call context and expertise types or speaks the initial greeting, which the AI Voice Engine and Voice Twin Synthesizer 122 renders in the designated voice persona. Because the greeting content is authored and manually triggered by a human, and the call is initiated by a manual “click-to-dial” or equivalent action, this process complies with Telephone Consumer Protection Act (TCPA) requirements for human initiation. The AI voice system does not autonomously originate the initial message, but rather serves as a voice conduit for the human operator.

In some embodiments, prior to call initiation, the system selects an available human operator from a pool based on the call type, subject matter, historical performance, and current workload. The selected operator authors the initial outreach message—by typing into the operator console or by speaking to the system—which is then rendered to the recipient using the designated AI voice model (e.g., the principal's “AI twin”). The system logs flags denoting human initiation and human authorship of the opening message, with the AI limited to voice synthesis for that message. This workflow supports jurisdictions that distinguish between human-authored content and automated bot dialing/scripting.

In some embodiments, the system may select the most suitable human operator from a pool of available staff based on the call's purpose, customer profile, and required domain expertise. The operator may not be the same person whose voice model is used for the AI twin; the AI Voice Engine 122 ensures that the customer consistently hears the same representative voice (e.g., “Pavan's AI Twin”) regardless of which operator is behind the scenes. If, during the conversation, the customer addresses a specific operator by name (e.g., “Sally”), the AI-Human Collaboration and Override System 130 can pause autonomous responses and enable that operator to respond directly. The operator's typed or spoken input may then be rendered in the operator's own synthesized voice, preserving the natural flow of conversation.

In some embodiments, during the call, the operator interacts with the Operator Console and Chat Interface 124, which serves as the primary dashboard for monitoring conversation flow, approving AI-suggested responses, and selecting emotional tone adjustments. The console displays live transcriptions, sentiment indicators, and override controls.

In some embodiments, the operator may guide the emotional tone of the AI voice in real time using the Emotion Control Interface 128, which allows for manual selection of preset emotional modes (e.g., “Celebrate,” “Show Urgency”). The selected emotional setting is transmitted to the AI Voice Engine 122, enabling the output voice to reflect the desired affective tone. The emotional mode selection is also displayed back to the operator for confirmation.

In some embodiments, if the conversation changes paths—e.g., the topic requires different expertise—the AI-Human Collaboration and Override System can silently invite a second human with the appropriate expertise to co-monitor and contribute candidate text, while preserving a single, consistent outward voice to the customer (e.g., “Pavan's AI twin”). When the recipient directly addresses or requests a specific operator (e.g., “Sally”), the system suspends autonomous replies, prompts that operator to respond, and renders the operator's approved text in the operator's own voice model. All role switches, contributors, and applied voice models are recorded in the session log.

In some embodiments, operator confirmations and corrections may also specify which human authored a given utterance and which voice model was used to speak it. These labels are returned to the sentiment engine and the training module to improve future selection of the supervising operator and to maintain accurate attribution during multi-operator collaborations.

As the customer responds during the call, their voice input is captured and analyzed by the Sentiment Detection and Mood Tracking Engine 126, which uses natural language processing and prosodic analysis to classify sentiment states such as frustration, excitement, or confusion. These sentiment cues are routed to the AI-Human Collaboration and Override System 130, which evaluates whether operator takeover or escalation is required. If mood-based escalation triggers are met, the system pauses AI output and enables direct human response or fallback protocols.

In some embodiments, the sentiment detection and mood tracking engine 126 also receives input from the operator indicating whether the system's emotional classification is accurate. For instance, if the system classifies the user's tone as “frustrated” but the operator determines that the user is actually confused or neutral, the operator can confirm or correct the classification using the console interface 124. These corrections are logged as “operator-labeled emotion confirmations” and routed to the sentiment engine 126 and optionally to the training and behavioral adaptation module 132 for use in refining future classification accuracy.

In some embodiments, the operator console supports a type-to-speak mode that allows personnel—including operators with speech impairments or those experiencing voice fatigue—to participate without speaking aloud; the AI renders their input in the selected voice model. A real-time safety filter shields the operator from abusive or toxic recipient language by redacting such content in the console while allowing the system to take over temporarily, de-escalate, or end the call according to policy thresholds. All such events are logged for audit and training.

The AI-Human Collaboration and Override System 130 also interfaces bidirectionally with the Operator Console 124, allowing real-time coordination between AI-generated and human-curated responses. In parallel, it logs override behavior data to the Training and Behavioral Adaptation Module 132, which uses these interactions to refine AI behavior, emotional tone prediction, and future fallback strategies.

Policy-level compliance functions are handled by the Compliance and Disclosure Subsystem 134, which receives configuration inputs and rule updates from the Training Module 132 and applies disclosure logic to ensure that required legal or regulatory disclosures (e.g., AI presence announcements) are delivered correctly. It also defines tone constraints and other content moderation settings used by the sentiment and voice generation modules.

The client device 110 receives voice output (from either the AI system or a human operator), and user input is returned for processing through this tightly integrated loop. The diagram illustrates how control and data flow dynamically between automation (AI response generation), emotional tone modulation, human oversight, and training infrastructure, ensuring a balance of personalization, compliance, and trust.

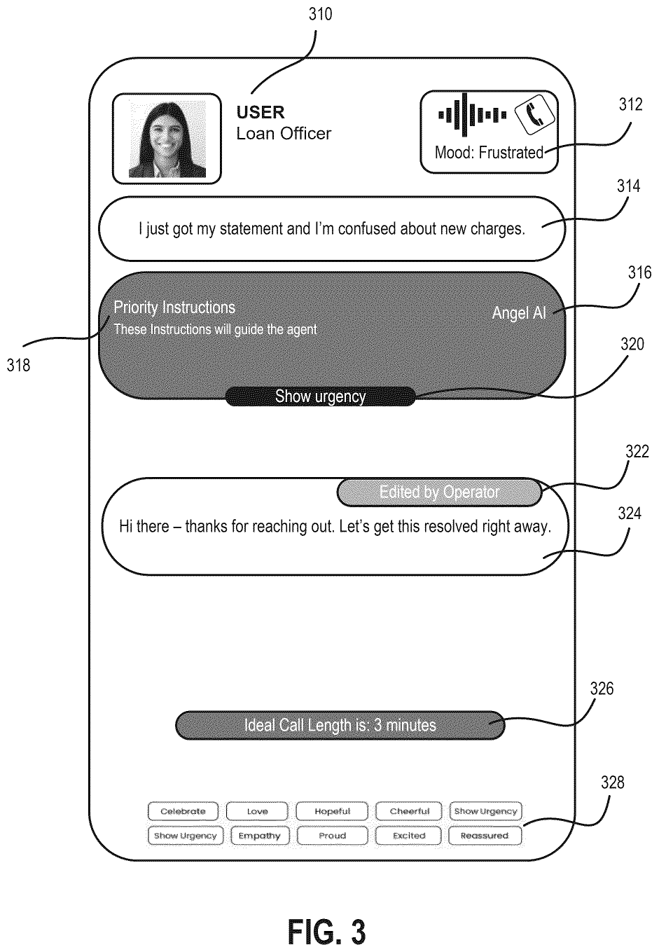

FIG. 3 illustrates a user interface 310 for a human operator interacting with a live AI voice call system. The interface displays a real-time customer sentiment indicator 312 (e.g., “Mood: Frustrated”) based on analysis performed by the Sentiment Detection and Mood Tracking Engine 126. A corresponding customer message 314, such as “I just got my statement and I'm confused about new charges,” is rendered in the chat feed for operator review.

Below the customer message, the system presents AI-generated priority instructions 316 within a stylized response block attributed to “Angel AI.”

These instructions 318 are intended to guide the operator's communication strategy, such as offering empathy, reassurance, or urgency depending on customer sentiment. In the illustrated embodiment, the system highlights a suggested tone of “Show Urgency” 320, as determined by the Emotion Control Interface 128 or automatically triggered by the AI-Human Override System 130.

The operator has the ability to approve, edit, or rewrite the suggested response. In this case, the operator modifies the AI-suggested output, resulting in an edited response 324, e.g., “Hi there—thanks for reaching out. Let's get this resolved right away.” A visual label 322 (“Edited by Operator”) indicates that the human has intervened prior to voice rendering. This interaction is managed via the Operator Console and Chat Interface 124 and logged by the Training and Behavioral Adaptation Module 132.

Below the message pane, the system displays an optional call duration guide 326 (e.g., “Ideal Call Length is: 3 minutes”) to help the operator manage efficiency while preserving empathy. The lower section includes emotion control buttons 328 such as “Celebrate,” “Empathy,” “Show Urgency,” and “Reassured.” These controls allow the operator to manually influence the prosody and delivery of the AI voice output through the Emotion Control Interface 128.

This figure illustrates a hybrid AI-human collaboration flow in which operator interaction, emotional modulation, and system intelligence combine to generate tone-appropriate, compliant, and humanized voice responses in real time.

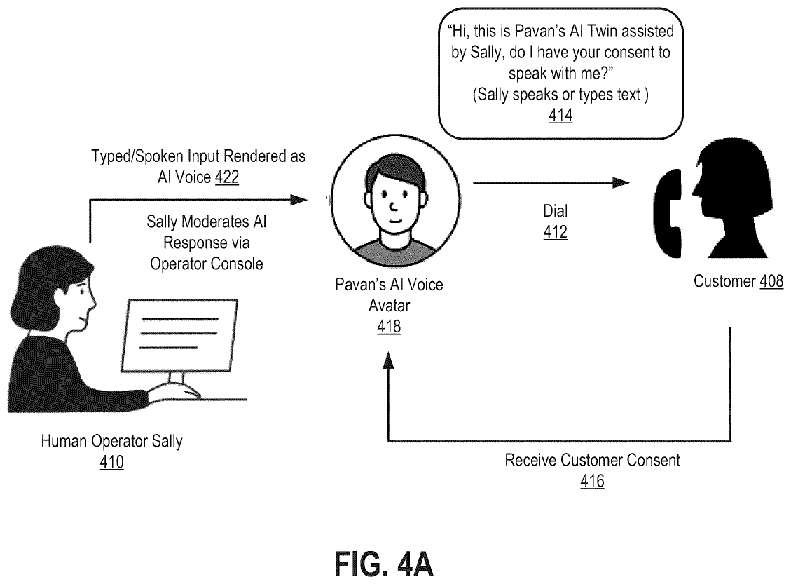

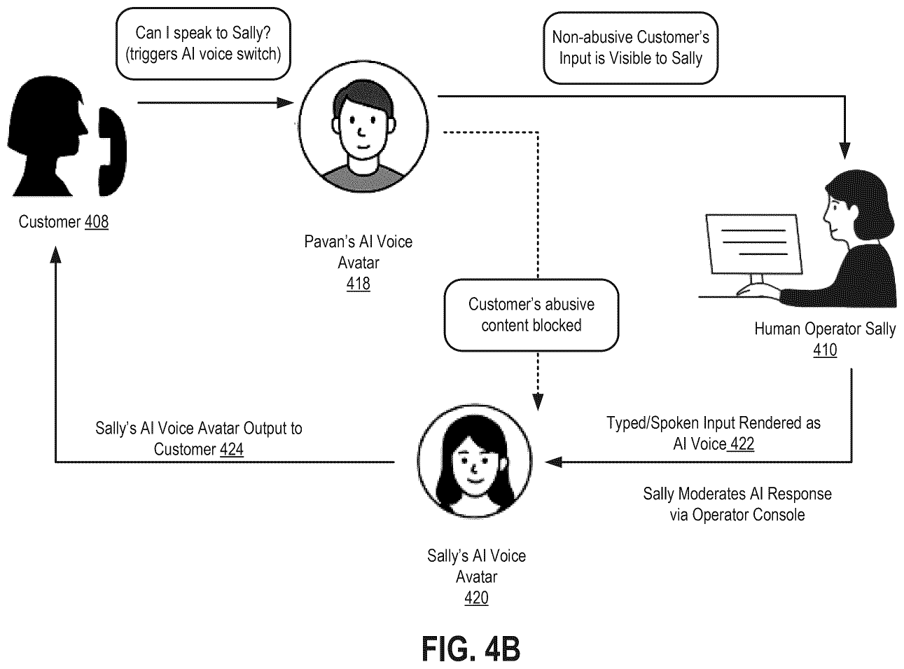

FIGS. 4A and 4B depict complementary voice call workflows enabling real-time collaboration between a live human operator and one or more AI-generated voice avatars, structured to comply with legal disclosure requirements, optimize operator assignment, protect human operators from abusive content, and enhance emotional alignment during customer outreach.

In FIG. 4A, a human operator 410 is selected by the AI system from a pool of available personnel based on the type of outbound call, subject matter, and the human's expertise. The operator then manually initiates the outbound call by triggering a dial action 412, such as selecting a contact and clicking a “Dial” button. This human-initiated dialing step ensures that the call is not automatically generated, preserving compliance with TCPA and similar regulations.

Upon connection, the first spoken message is generated entirely from human-authored input. The operator either types or speaks an introductory disclosure 414, which the AI renders in the consistent voice persona of the designated AI twin—shown in FIGS. 4A and 4B as Pavan's AI Voice Avatar 418—(e.g., “Hi, this is Pavan's AI twin, assisted by Sally on a recorded line, calling about . . . ”). The consistent AI voice helps create continuity for the customer, even when the human operator providing the input may differ between calls. This disclosure explicitly informs the customer of the presence of an AI voice, thereby satisfying regulatory transparency requirements. The system records whether customer consent 416 is received before continuing the interaction.

In FIG. 4B, if the customer 408 directs a question or request to the human assistant (e.g., “I want to speak to Sally”), Pavan's AI Voice Avatar 418 instantly switches modes to stop autonomous response generation, prompting the human to provide the reply. The reply is then rendered in the human's own AI voice avatar 420 by the AI voice synthesis engine and output to the customer 424. During this process, the system can detect abusive or inappropriate language from the customer. Non-abusive customer input is passed through to the human operator 410, while abusive content is intercepted, preventing the human from hearing it, and instead allowing the AI to respond directly.

Throughout both workflows, the operator moderates AI behavior through an interface 422 connected to the Operator Console and Chat Interface 124. This may include typing responses, selecting emotional tone controls via the Emotion Control Interface 128, or pausing the AI voice mid-stream using override logic in the AI-Human Collaboration and Override System 130. The “typed/spoken input rendered as AI voice” pathway preserves the human origin of all outbound call speech while allowing for consistent voice branding through the AI avatar 418 or 420.

This architecture supports accessibility by enabling employees with speech impairments or physical limitations to fully participate in voice-based customer service roles, reducing fatigue from continuous speaking. It further preserves a human-in-the-loop supervisory model, supports escalation to specialist agents when needed, and provides training signals to the Training and Behavioral Adaptation Module 132 based on operator interventions and AI/human voice-switch events.

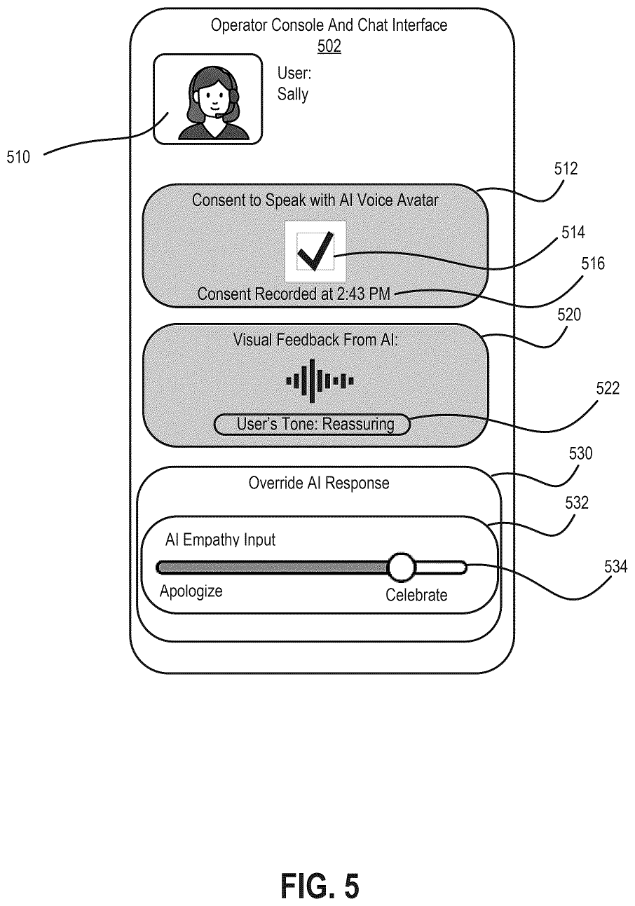

FIG. 5 depicts an example graphical user interface (GUI) 502 presented to a human operator (e.g., Sally), who oversees a live AI voice interaction. The operator's identity and role are shown via a user profile section 510, which may include a name and photo for context and accountability.

A consent verification region 512 confirms that the recipient has agreed to proceed with the AI-assisted call. A visual indicator 514 (e.g., a checkmark) affirms consent, and a timestamp 516 records when consent was logged. This interface may be linked to the Compliance and Disclosure Subsystem 134 for real-time auditing and consent verification.

A feedback panel 520 displays dynamic tone-related signals received from the Sentiment Detection and Mood Tracking Engine 126. In this embodiment, the AI reports that the customer's current mood is “Reassuring,” shown via text 522 and optionally visualized using audio waveform graphics or sentiment bars.

Below, an override region 530 enables the operator to take corrective action or guide the emotional tone of the AI's next response. A textual label 532 identifies the control, while an empathy slider 534 allows the operator to adjust AI tone between, for example, “Apologize” and “Celebrate.” This real-time adjustment is processed by the Emotion Control Interface 128 and dynamically modulates AI speech characteristics such as pace, pitch, and word choice.

This user interface enables dynamic AI-human collaboration during live conversations, improves system transparency, and supports both emotional alignment and regulatory compliance during voice-based customer engagement.

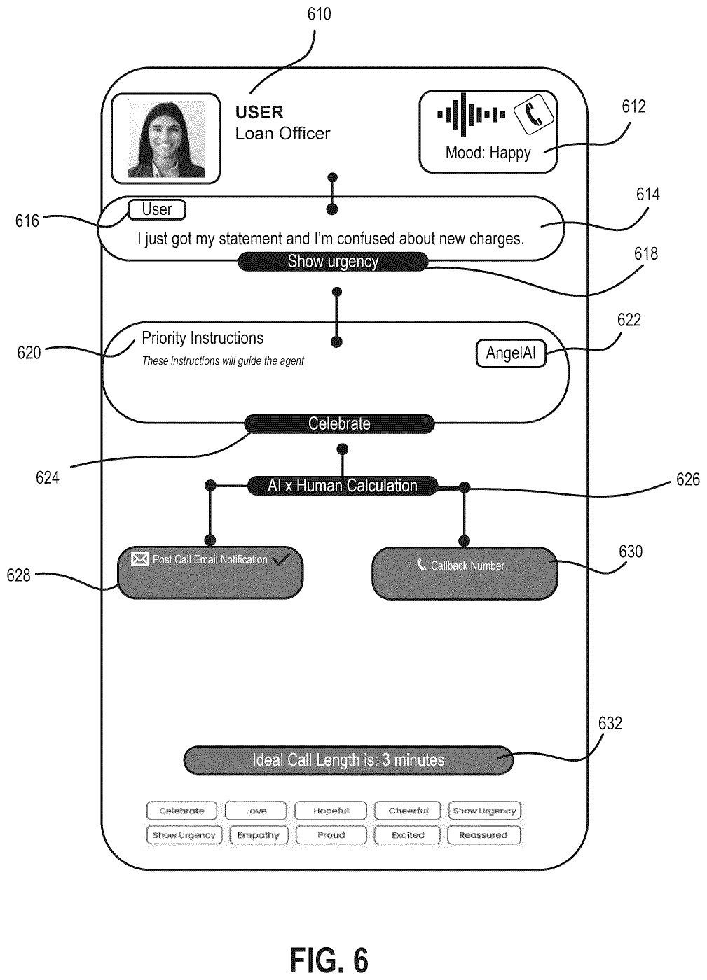

FIG. 6 illustrates a graphical user interface presented to a human operator during a live AI-assisted voice interaction. The interface combines real-time emotional feedback, AI-human collaboration controls, and intelligent follow-up tools to support emotionally attuned and adaptable communication workflows.

A user profile panel 610 displays the customer identity, along with a dynamic mood indicator 612 generated by the sentiment detection and mood tracking engine 126. In the illustrated example, the user's detected sentiment is “Happy,” based on voice tone, pacing, and linguistic cues.

A live transcript of the user's recent message 616 is shown, with a contextual emotional tag 618 such as “Show Urgency” to guide the operator's tone. This recommendation may be derived automatically or selected manually through the emotion control interface 128. Below, a priority instruction panel 620 provides AI-generated contextual guidance, such as suggested phrasing or tone. The AI attribution label 622 identifies the source as AI system (e.g., “AngelAI”).

A selected emotional tone, such as “Celebrate,” is confirmed in the response flow via tag 624. In scenarios involving ambiguity or unfamiliar queries, the system invokes an AI×Human Calculation stage 626, powered by the collaborative resolution engine 138. This stage combines suggestions from the AI and the human operator to co-create a final, emotionally aligned message.

Based on historical behavior data and contextual cues, the system may also recommend follow-up actions, including sending a post-call email (button 628) or providing a callback number (button 630). These actions are informed by the interaction history and strategy adaptation engine 136, which aggregates patterns from prior voice calls, email engagements, and user-specific context to determine what follow-up strategies have been most effective in similar scenarios. In some embodiments, the system detects when a call routes to voicemail and automatically transitions to email-based communication. The AI system then monitors whether the recipient opens the email and uses that signal to determine the optimal timing for re-engagement, thereby increasing the likelihood of a successful outcome.

A guidance banner 632 displays an ideal call duration, such as “3 minutes,” to help balance efficiency and engagement. Emotion buttons shown along the bottom of the interface allow real-time adjustment of AI tone using quick-select presets, further enabling the operator to guide the conversation with empathy and precision.

Together, these interface components provide a unified control environment that allows operators to monitor sentiment, adapt tone, collaborate with the AI, and manage post-call strategy—supporting an emotionally intelligent, compliant, and adaptable voice assistant workflow.

FIG. 7 illustrates a graphical user interface for visualizing dynamic emotional states detected during a live AI voice interaction. The interface includes a vertical sidebar populated with mood indicators 712-726, each representing a distinct emotional state using a stylized waveform icon and textual label.

The mood states may include, for example, “Happy” 712, “Sad” 714, “Angry” 716, “Nervous” 718, “Loving” 720, “Excited” 722, “Empathetic” 724, and “Celebratory” 726. These labels are generated in real time by the sentiment detection and mood tracking engine 126, which evaluates speech-based signals such as tone, pacing, word choice, and conversational flow dynamics.

Each waveform serves as a visual signature of the user's emotional state, forming part of the system's dynamic emotion wave model. This model continuously updates as the conversation progresses, enabling the system to respond with tone-matched voice modulation or escalate to human intervention as needed. In some embodiments, these waveform icons are updated in-place to reflect emotional transitions or amplified in response to spikes in detected sentiment.

To enhance collaboration and ensure human oversight, the system may generate real-time alerts when it detects a significant change in user emotion or engagement. These alerts are presented to the operator via the console interface 124, allowing the human to intervene with the appropriate emotional response. This alerting mechanism functions similarly to a nurse monitoring a patient's vital signs, empowering the operator to step in precisely when human intuition is most needed.

The dynamic emotion wave model thus allows the system to deliver highly adaptive and empathetic responses, creating interactions that mirror natural human understanding while retaining the efficiency and scalability of AI-driven voice systems.

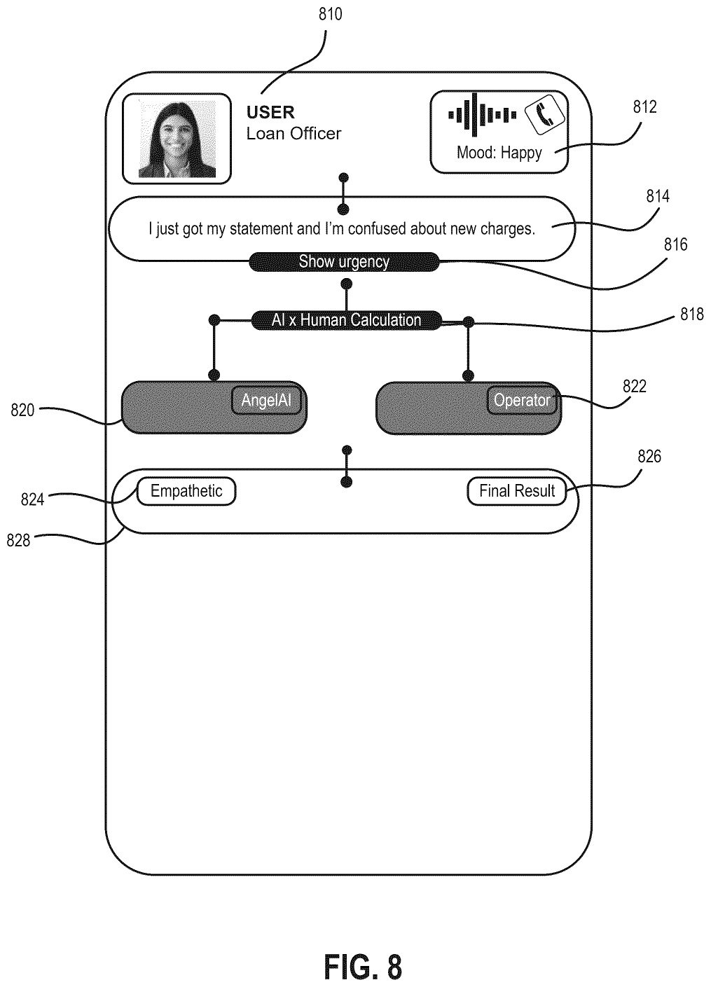

FIG. 8 illustrates a graphical user interface that supports real-time collaborative response generation between the AI system and a human operator. This interface represents a key phase of the “AI×Human Calculation” workflow implemented by the Collaborative Resolution Engine 138, used when the system encounters novel, ambiguous, or high-context scenarios during a live call.

The interface begins with a user profile section 810, which displays the identity of the user and a dynamic mood indicator 812 generated by the sentiment detection and mood tracking engine 126. The user's message 814—e.g., “I just got my statement and I'm confused about new charges”—is shown in context, alongside a recommended tone tag 816 (e.g., “Show urgency”) selected by the operator or suggested by the emotion control interface 128.

Upon determining that a standard AI response is insufficient or ambiguous, the system triggers the AI×Human Calculation node 818. This control point represents the invocation of the collaborative resolution process. The interface then displays candidate responses from both the AI system 820 and the human operator 822. These may be generated in parallel or sequentially, depending on system confidence and workflow settings.

The operator may edit, accept, or merge the candidate outputs using the operator console and chat interface 124. The finalized response 826 is constructed as a unified, context-sensitive message labeled with emotional framing 824 (e.g., “Empathetic”), ensuring that the delivery reflects both logical appropriateness and emotional resonance.

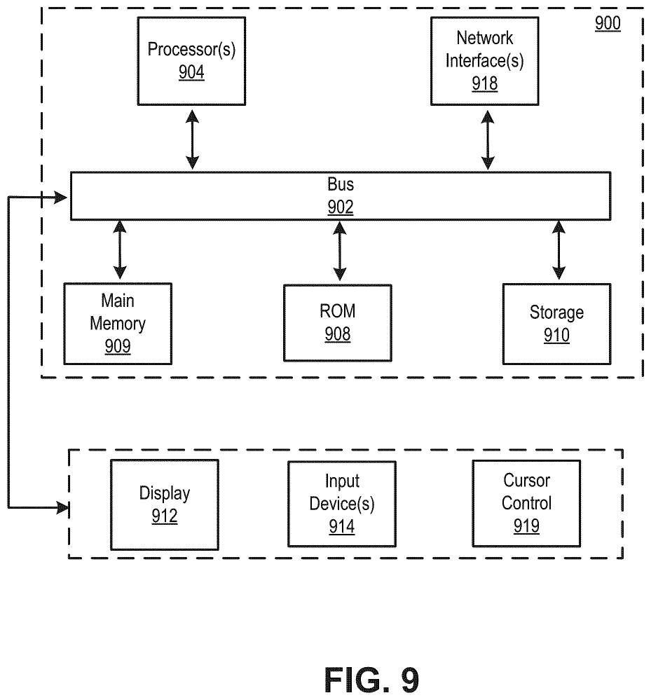

The resulting message is output as the system's final response 828 and delivered to the user via the AI voice engine 122, rendered in the appropriate voice model. This collaborative decision process ensures that sensitive, ambiguous, or edge-case interactions are handled with a blend of machine efficiency and human nuance, improving both accuracy and trust in emotionally charged scenarios.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 9. Various embodiments are described in terms of this example computing module 900. After reading this description, it will become apparent to a person skilled in the relevant art how to implement the technology using other logical circuits or architectures.

FIG. 9 illustrates an example computing module 900, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALS, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 3. Various embodiments are described in terms of this example-computing module 900. After reading this description, it will become apparent to a person skilled in the relevant art how to implement the application using other computing modules or architectures.

Referring now to FIG. 9, computing module 900 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 900 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 900 might include, for example, one or more processors, controllers, control modules, or other processing devices, such as a processor 904. Processor 904 might be implemented using a general-purpose or special-purpose processing engine such as, for example, a microprocessor, controller, or other control logic. In the illustrated example, processor 904 is connected to a bus 902, although any communication medium can be used to facilitate interaction with other components of computing module 900 or to communicate externally. The bus 902 may also be connected to other components such as a display 912, input devices 914, or cursor control 916 to help facilitate interaction and communications between the processor and/or other components of the computing module 900.

Computing module 900 might also include one or more memory modules, simply referred to herein as main memory 906. For example, preferably random-access memory (RAM) or other dynamic memory might be used for storing information and instructions to be executed by processor 904. Main memory 906 might also be used for storing temporary variables or other intermediate information during execution of instructions to be executed by processor 904. Computing module 900 might likewise include a read only memory (“ROM”) 908 or other static storage device 910 coupled to bus 902 for storing static information and instructions for processor 904.

Computing module 900 might also include one or more various forms of information storage devices 910, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 910 might include other similar instrumentalities for allowing computer programs or other instructions or data to be loaded into computing module 900. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 900.

Computing module 900 might also include a communications interface or network interface(s) 918. Communications or network interface(s) interface 918 might be used to allow software and data to be transferred between computing module 900 and external devices. Examples of communications interface or network interface(s) 918 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 918 might typically be carried on signals, which can be electronic, electromagnetic (which includes optical) or other signals capable of being exchanged by a given communications interface. These signals might be provided to communications interface 918 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 906, ROM 908, and storage unit interface 910. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 900 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for conducting a voice-based interaction using an AI-generated voice under live human supervision, comprising:
initiating, by a human operator via a graphical user interface, an outbound voice call to a recipient;
transmitting, by the computing system, a disclosure statement rendered in a human voice or typed by the operator and synthesized using text-to-speech, the disclosure identifying the use of an AI-generated voice during the interaction;
receiving, by the computing system, an indication of consent from the recipient to proceed with the AI-assisted voice interaction;
generating, using an AI voice engine, a synthetic voice response based on an operator-approved text message or an AI-suggested message confirmed by the operator;
modulating, by an emotion control interface, at least one of a tone, pitch, or pace of the synthetic voice response based on an emotional tone selection input by the operator;
delivering the synthetic voice response to the recipient;
receiving, during the voice interaction, real-time sentiment data derived from the recipient's speech; and
logging, by a training module, operator interventions, tone adjustments, and sentiment signals to update behavior models for future interactions.

2. The method of claim 1, wherein the operator delivers the initial disclosure message either by manually speaking or by triggering a text-to-speech output using a predefined voice model.

3. The method of claim 1, further comprising storing an indication of consent from the recipient along with a timestamp in a compliance log.

4. The method of claim 1, wherein generating the AI voice response includes synthesizing speech using a voice profile that mimics the vocal characteristics of a designated human, such as a loan officer or representative.

5. The method of claim 1, wherein the operator adjusts the emotional tone of the AI response using a graphical user interface with selectable options comprising “Celebrate,” “Empathize,” “Show Urgency,” “Reassure,” and “Apologize.”

6. The method of claim 1, further comprising analyzing the recipient's spoken input to detect emotional sentiment and displaying a corresponding mood indicator to the operator.

7. The method of claim 1, further comprising recording operator interactions, sentiment feedback, and override actions as training data for refining future AI behavior.

8. The method of claim 1, wherein delivery of the AI-generated voice output is temporarily paused or overridden in response to manual intervention by the operator.

9. A computer-implemented system for managing avatar-based interactions, comprising:
a voice call initiation module configured to initiate an outbound voice call to a recipient based on a human operator's command;
a consent and disclosure module configured to present a disclosure message to the recipient identifying the AI system and human operator;
a text-to-speech engine configured to generate an AI voice response using a selected voice profile based on either automated AI text output or operator-provided input;
an operator console comprising a graphical user interface that enables the human operator to:
view the conversation in real time;
approve or edit AI-generated messages prior to delivery;
override AI responses with manually entered text; and
select among predefined emotional tone controls;
a sentiment analysis engine configured to evaluate recipient voice input and generate a corresponding emotional state classification;
an emotion modulation engine configured to adjust the prosody, pitch, and language style of the AI voice based on an output from the sentiment analysis engine or real-time operator input;
a behavioral training module configured to log operator interactions, sentiment classifications, override events, and emotional tone selections as training data for adaptive learning;
a compliance and audit subsystem configured to record disclosure events, consent confirmation, and call metadata for regulatory purposes.

10. The system of claim 1, wherein the AI voice engine is further configured to synthesize speech in a voice model corresponding to a real human representative.

11. The system of claim 1, wherein the operator console comprises an empathy control interface that includes one or more quick-select buttons corresponding to emotional states, including “reassure,” “apologize,” “celebrate,” and “show urgency.”

12. The system of claim 1, wherein the sentiment analysis engine applies natural language processing and audio signal analysis to infer emotional state from user speech during the voice call.

13. The system of claim 1, wherein the emotion modulation engine automatically adjusts voice parameters in response to changes in inferred sentiment detected during the voice interaction.

14. The system of claim 1, wherein the AI-human collaboration module is further configured to pause the AI-generated voice output in response to operator input and enable manual takeover by the operator.

15. The system of claim 1, wherein the training module stores override behavior, sentiment transitions, and operator input as training signals for subsequent AI model fine-tuning.

16. The system of claim 1, wherein the system includes a compliance module configured to log consent status, voice model identity, and disclosure events associated with the AI-generated voice call.

17. The system of claim 1, wherein the synthesized voice greeting includes a disclosure that the voice is an AI-generated representation of a specific individual.

18. The system of claim 1, wherein the operator console includes a text input field configured to convert typed operator messages into synthesized speech output by the AI voice engine.
